(19) United States
(12) Patent Application Publication
(10) Pub. No.: US 2009/0053529 A1
(43) Pub. Date: Feb. 26, 2009

(54) ROOFING SHEET MATERIAL

(75) Inventors: Maryann C. Kenney, Foxboro, MA (US); Gwo S. Swei, Vandalia, OH (US); Giorgio Bortolotto, Boston, MA (US); Christian C. Honeker, Acton, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 12/196,081

(22) Filed: Aug. 21, 2008

Related U.S. Application Data
(60) Provisional application No. 60/957,054, filed on Aug. 21, 2007.

(51) Int. Cl. B32B 27/30; E04D 5/10; B32B 27/28; B32B 27/06; B32B 11/04

(52) U.S. Cl. 428/422; 428/421; 156/243

(57) ABSTRACT

A roofing material includes a bitumen sheet material and a multilayer capping film. The multilayer capping film includes a first layer comprising a first fluoropolymer and a second layer underlying the first layer. The second layer includes at least 40 wt % of a second fluoropolymer and not greater than 60 wt % of an acrylic polymer. The second layer of the multilayer capping film overlies the bitumen sheet material and the first layer of the multilayer capping film forms an outer surface of the roofing material.

### CROSS REFERENCE TO RELATED APPLICATION(S)

The present application is a non-provisional application of U.S. Provisional Patent Application No. 60/957,054, filed Aug. 21, 2007, entitled “ROOFING SHEET MATERIAL,” naming inventors Maryann C. Kenney, Gwo S. Swei, and Giorgio Bortolotto, which application is incorporated by reference herein in its entirety.

### FIELD OF THE DISCLOSURE

This disclosure, in general, relates to roofing sheet materials and methods for manufacturing such roofing sheet materials.

### BACKGROUND

Within the construction industry, builders and building owners are seeking cost effective roofing solutions. In particular, builders and building owners are seeking low maintenance and long lasting roofing materials that provide protection against environmental hazards, such as rain, snow, hail, wind, heat, and ultraviolet radiation. More recently, the construction industry has also been tasked with using materials that have a lower impact on the environment.

While bitumen or asphalt-based roofing materials exhibit desirable resistance to rain, snow, hail, and wind, such materials tend to absorb solar energy and create heat. Hot roofing materials contribute to the urban heat island effect and lead to increased energy use. On a sunny day, such bitumen roofing materials may far exceed ambient temperatures. For example, a typical black roof may be 70° F. (21° C.) higher than the ambient temperature on a sunny day. Such heat is passed to the surrounding area, especially in concentrated and developed or urban areas.

In addition, such bitumen or asphalt-based roofing materials tend to release volatile organic components from the roofing sheet material. Such volatile organic components may contribute to the formation of smog and urban air pollution, degrading the air quality in urban settings. Further, the loss of lighter compounds from the roofing material may increase the brittleness of the roofing material over time, reducing the durability of such materials.

More recently, states, such as California, have implemented building standard that require “cool” or “green” roofing technologies. In particular, such roofing technologies seek to increase reflection of sunlight. To meet such standards, many roofing material manufactures have turned to alternative materials as replacement for bitumen materials. However, such materials tend to be more expensive, are less reliable when faced with harsh environmental conditions, and are more difficult to repair.

In products that still use bitumen as a base material, attempts have been made to alter the color of the material or to add light colored coatings over the bitumen material. Often, however, the volatile components, oils and other colored components of the bitumen material leach into such coatings, causing discoloration. Such discoloration reduces the effectiveness of the coating to reflect solar energy and shortens the life of the roof coating material. Additionally the coating process requires care and adequate thickness to achieve acceptable barrier.

In addition, roofing products with light colored surfaces are susceptible to staining and darkening from atmospheric pollutants and dust during exposure. Because of this the desired surface reflectivity is often reduced over time.

As such, an improved roofing sheet material would be desirable.

### SUMMARY

In a particular embodiment, a roofing material includes a bitumen sheet material and a multilayer capping film. The multilayer capping film includes a first layer comprising a first fluoropolymer and a second layer underlying the first layer. The second layer includes at least 40 wt % of a second fluoropolymer and not greater than 60 wt % of an acrylic polymer. The second layer of the multilayer capping film overlies the bitumen sheet material and the first layer of the multilayer capping film forms an outer surface of the roofing material.

In another exemplary embodiment, a roofing material includes a bitumen sheet material and a multilayer capping film in direct contact with the bitumen sheet material. The roofing material exhibits a cold flex rating of pass.

In a further exemplary embodiment, a capping film includes coextruded first and second layers. The first layer includes a fluoropolymer. The second layer includes greater than 50 wt % of a vinylidene fluoride copolymer, not greater than 40 wt % acrylic polymer, and at least 5 wt % of an inorganic filler. The vinylidene fluoride copolymer includes 5 wt % to 30 wt % hexafluoropropylene.

In an additional embodiment, a method of forming a roofing material includes dispensing a bitumen sheet material, dispensing a capping film, and laminating the capping film to the bitumen sheet material. The capping film includes a first layer comprising a first fluoropolymer and forming an outer layer and includes a second layer underlying the first layer. The second layer includes at least 40 wt % of a second fluoropolymer and not greater than 60 wt % of an acrylic polymer.

### BRIEF DESCRIPTION OF THE DRAWINGS

The present disclosure may be better understood, and its numerous features and advantages made apparent to those skilled in the art by referencing the accompanying drawings.

FIGS. 1 and 2 include illustrations of exemplary roofing sheet materials.

FIG. 3 includes a flow diagram illustration of an exemplary method for manufacturing a roofing sheet material.

FIG. 4 includes an illustration of an exemplary apparatus for forming a roofing sheet material.

FIG. 5 includes an illustration of an exemplary roofing sheet material.

FIG. 6 includes an illustration of an exemplary merchandised roofing sheet material article.

FIG. 7 includes an illustration of an exemplary structure including a roofing sheet material.

FIG. 8 includes a flow diagram illustration of an exemplary method of use for a roofing sheet material.

### DESCRIPTION OF THE DRAWINGS

In an exemplary embodiment, a roofing sheet material includes a multilayer fluoropolymer capping film and a roofing substrate material. The multilayer capping film may include at least two layers. One layer may include fluoropolymer and may form an outer surface of the roofing sheet material. A second layer may include a blend of an acrylic polymer and fluoropolymer. The second layer may also include a pigment. In an example, the roofing substrate material is a bitumen sheet material, such as a modified bitumen material. A third layer may be included to facilitate bonding to the bitumen material and may include a blend of adhesive polymer and optionally a fluoropolymer.

In a further example, a method of forming a roofing sheet material includes providing a fluoropolymer capping film and adhering the fluoropolymer capping film to a roofing substrate material. For example, the roofing substrate material may be extruded or coated on to the capping film. In another example, the roofing substrate material may be cured when in contact with the capping film. In a further example, the capping film may be laminated to the roofing substrate material, such as through heat laminating.

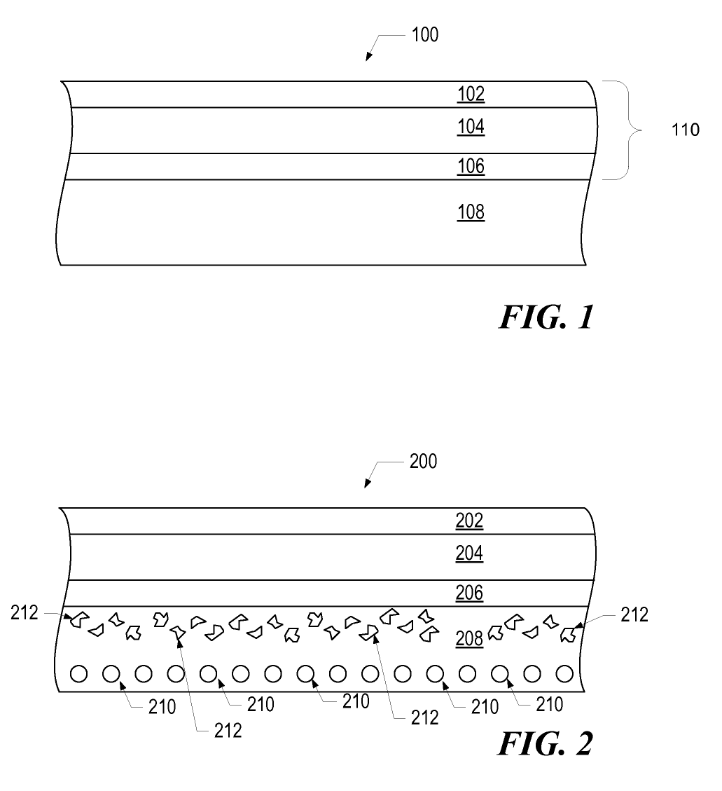

As illustrated in FIG. 1, an exemplary roofing sheet material 100 may include a capping film 110 overlying a roofing substrate material 108. The capping film 110 may be a multilayer film, as illustrated. For example, the capping film 110 may include at least two layers, such as at least three layers. Alternatively, the capping film 110 may be formed of a single layer.

In a particular example, the capping film 110 includes an outer layer 102 formed of a low surface energy material, such as a polymer component resistant to chemical or environmental exposure. As illustrated, the outer layer 102 may overlie an intermediate layer 104, which, in turn, may overlie an adhesive layer 106. In an example, the outer layer 102 may be in direct contact with the intermediate layer 104, such as without intervening layers, and the intermediate layer 104 may be in direct contact with the adhesive layer 106. Alternatively, the capping film 110 may not include an adhesive layer 106 and the intermediate layer 104 may act as an adhesive layer.

In an embodiment, the outer layer 102 is generally formed of a low surface energy material useful in forming a low surface energy surface. In particular, the outer layer 102 includes a polymer component resistant to chemical or environmental exposure. In another exemplary embodiment, the material may have nonstick properties and be resistant to staining. In an example, a low surface energy polymer includes a fluoropolymer. An exemplary fluoropolymer may be formed of a homopolymer, copolymer, terpolymer, or polymer blend formed from a fully or partially fluorinated monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. An exemplary fluoropolymer includes a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), a terpolymer including tetrafluoroethylene, hexafluoropropylene, and vinylidenefluoride (THV), ethylene-perfluoroethylenepropylene copolymer (EFEP), or any blend or any alloy thereof. For example, the fluoropolymer may include FEP. In a further example, the fluoropolymer may include PVDF. In an exemplary embodiment, the fluoropolymer may be crosslinkable through radiation, such as e-beam. An exemplary crosslinkable fluoropolymer may include ETFE, THV, PVDF, or any combination thereof. A THV resin is available from Dyneon 3M Corporation Minneapolis, Minn. An ECTFE polymer is available from Ausimont Corporation (Italy) under the trade name Halar. Other fluoropolymers described herein may be obtained from Daikin (Japan) and DuPont (USA).

In particular, the outer layer 102 may include a fluorinated polymer, such as a polyvinylidene fluoride (PVDF) homopolymer or a PVDF copolymer, such as vinylidene fluoride/hexafluoropropylene copolymer. Many fluoropolymers are commercially available from suppliers in various grades. For example, suppliers can supply multiple resins having nominally the same composition but different properties, such as different molecular weights to provide specific viscosity characteristics. Exemplary PVDF polymers include PVDF 1010 and PVDF 21510 by Solvay or Kynar or Kynar Flex polymers available from Arkema. It is contemplated that the fluoropolymer component of the outer layer 102 can include a melt blend of multiple fluoropolymers in place of one such polymer. Alloys of PVDF homopolymer and PVDF copolymer may provide the film with improved elastic modulus and flexibility. In one exemplary embodiment, the polymer may consist essentially of fluorinated polymer.

In a particular example, the fluoropolymer of the outer layer 102 includes a copolymer of vinylidene fluoride and hexafluoropolymer. For example, the copolymer may includes hexafluoropropylene in a range of 5 wt % to 30 wt %, such as a range of 5 wt % to 20 wt %, or even a range of 5 wt % to 15 wt %.

In an example, the outer layer 102 includes at least about 70% by weight fluoropolymer, such as at least about 75% by weight, or even at least about 80% by weight fluoropolymer. In a particular example, the outer layer 102 is formed substantially of fluoropolymer, such as including about 100% fluoropolymer or consisting essentially of fluoropolymer. Alternatively, the outer layer 102 may include a pigment, a UV absorber, another additive described below, or any combination thereof.

In an exemplary embodiment, the outer layer 102 has a thickness not greater than about 125 micrometers. For example, the thickness of the outer layer 102 may be not greater than about 50 micrometers, such as not greater than about 25 micrometers, or even, not greater than about 12 micrometers. In a particular example, the outer layer 102 has a thickness of not greater than 6 micrometers, such as in a range of 2 micrometers to 6 micrometers.

In an exemplary embodiment, the capping film 110 may include an intermediate layer 104. While the intermediate layer 104 is illustrated as a single layer, the intermediate layer 104 may be formed of one or more layers, such as at least two layers, or even at least three layers. In an example, the intermediate layer 104 may include a component with desirable mechanical properties, such as cold temperature mechanical properties, which are manifested in the resulting multilayer film. Such mechanical properties include, for example, elongation or flexibility. These properties, for example, may be similar to the properties of fluoropolymer film. In one exemplary embodiment, the intermediate layer 104 comprises the low surface energy component in a blend of other components.

For example, the intermediate layer 104 may include a fluoropolymer in a blend with a second polymer. In one embodiment, the fluoropolymer of the intermediate layer 104 is a PVDF copolymer, such as the PVDF copolymer with hexafluoropropylene described above in relation to outer layer 102. In an example, the fluoropolymer is derived from the same monomer as the fluoropolymer of the outer layer 102. In particular, both the fluoropolymer of the outer layer 102 and of the intermediate layer 104 may be PVDF fluoropolymers, and may be the same grade or a different grade of PVDF fluoropolymer.

In a particular embodiment, the intermediate layer 104 may include at least about 20% by weight of a fluorinated polymer, such as those fluorinated polymers listed above, for example, a PVDF fluoropolymer. In addition, the intermediate layer 104 also may include a second polymer.

In an exemplary embodiment, the second polymer may exhibit resistance to volatile organic components of bitumen or asphalt. An exemplary second polymer includes acrylic polymer, polyvinyl acetate, polyvinylidene chloride, polyacrylonitrile, and cellulosic polymers, or any combination thereof. In an alternative embodiment, the intermediate layer 104 may include at least two layers. A first layer may include a blend of fluoropolymer, such as PVDF, and acrylic, and a second layer may include another polymer, such as polyvinyl acetate, polyvinylidene chloride, polyacrylonitrile, and cellulosic polymers, or any combination thereof.

In particular, the second polymer may, for example, be an acrylic polymer. In one exemplary embodiment, the acrylic polymer may be a branched acrylic polymer. In another exemplary embodiment, the acrylic polymer may be a linear acrylic polymer. The acrylic polymer may be derived from an alkyl group having from 1-4 carbon atoms, a glycidyl group or a hydroxyalkyl group having from 1-4 carbon atoms, or any combination thereof. A representative acrylic polymer may include polymethyl methacrylate, polyethyl methacrylate, polybutyl methacrylate, polyglycidyl methacrylate, polyhydroxyethyl methacrylate, polymethyl acrylate, polyethyl acrylate, polybutyl acrylate, polyglycidyl acrylate, polyhydroxyethyl acrylate, or any combination thereof.

In an exemplary embodiment, the acrylic polymer is an impact grade or impact modified acrylic. Impact-modified acrylic polymers generally comprise a copolymer of monomers of acrylic monomers with an effective amount of suitable comonomer or graft moiety to produce the desired elastic modulus and impact resistance. An acrylic elastomer, sometimes referred to as acrylate rubber, polyacrylate rubber, polyacrylic elastomer or “ACM” and which is a composition based on a mixture of a polyacrylate and polymethacrylate, a polyacrylate and ethylene methacrylate copolymer (“EMAC”), or a polyacrylate and ethylene butylacrylate (“EBAC”), may be used. Alternatively, a thermoplastic impact-modified acrylic polymer can be a blend of a clear glassy acrylic polymer, such as a plastic copolymer of ethylene and a carboxylic acid compound selected from acrylic acid, methacrylic acid or any combination thereof, with at least one elastomeric component.

The impact-modified acrylic polymer generally includes fine particles of the elastomer dispersed uniformly in the plastic copolymer. The impact grade acrylic may comprise transparent toughened thermoplastic blends prepared by blending 10 to 99 weight percent of a block copolymer; 0.1 to 1.0 weight percent of particulate rubber having a particle size from 0.1 to 10 microns; and the balance a clear glassy polymer.

Another suitable technique for making impact-modified acrylic polymer employs the use of a so-called “core/shell” product, such as Atofina DR-101 resin. These generally are polymer particles that have a central core of one polymer surrounded by a shell of another polymer. The core may be either the plastic or elastomer component and the shell is the opposite, i.e., elastomer or plastic component. The core/shell particles are fed to a melt mixing apparatus, such as a melt extruder in which the core and shell domains are blended in the melt phase to form a homogeneous blend on a much smaller scale and a film is formed from the extrudate of this homogeneous blend.

In a particular embodiment, the acrylic may be a linear impact modified acrylic. In a further exemplary embodiment, the acrylic may be a branched impact modified acrylic. Alternatively, a linear acrylic polymer that is not impact modified, such as those typically used in adhesive layers, may be used. In particular, when an adhesive acrylic polymer is used in sufficient quantity to be effective, an adhesive layer, such as the adhesive layer 106, may be absent from the capping film 110 and the intermediate layer 104 may be in direct contact with the roofing substrate layer 108, such as without intervening layers.

Returning to FIG. 1, the intermediate layer 104 may include at least about 30% by weight of the fluoropolymer, such as at least about 40% by weight or at least 50% by weight of the fluoropolymer. In particular, the intermediate layer 104 may include at least about 55% by weight fluoropolymer, such as at least about 60% by weight, at least about 75% by weight, at least about 80% by weight, or even, at least about 90% by weight fluoropolymer. Alternatively, the intermediate layer 104 may include the fluoropolymer in an amount not greater than about 90% by weight, such as not greater than about 80%, not greater than about 70%, or even not greater than about 50% by weight. For example, the intermediate layer 104 may include the fluoropolymer in a range of 40 wt % to 80 wt %, such as a range of 50 wt % to 80 wt %, a range of 55% to 80%, or even a range of 60 wt % to 80 wt %.

Conversely, the intermediate layer 104 may include not greater than about 60% by weight of a second polymer, such as not greater than about 40% by weight. For example, the intermediate layer 104 may include not greater than about 25% by weight of the second polymer, such as not greater than about 20% by weight, or even not greater than about 10% by weight of the second polymer. Excess amounts of the second polymer, such as excess amounts of acrylic, may lead to shrinkage in the capping film. Alternatively, the intermediate layer may include the second polymer in an amount of at least about 20% by weight, such as at least about 30%, or even at least about 35% by weight. For example, the intermediate layer 104 may include the second polymer in a range of 20 wt % to 60 wt %, such as a range of 20 wt % to 50 wt %, or even a range of 20 wt % to 40 wt %.

In particular, the intermediate layer 104 may include more fluoropolymer than the second polymer. For example, the intermediate layer 104 may include the fluoropolymer and the second polymer in a ratio of at least 1:1 fluoropolymer to second polymer. In an example, the ratio is at least 3:2, such as at least 7:3.

Further, the intermediate layer 104 may include inorganic fillers, organic fillers, antioxidants, UV additives, flame retardants, antidegradation additives, adjuvants, processing aids, or any combination thereof. For example, the intermediate layer 104 may include minor but significant fractions of antidegradation additives and adjuvants. In another example, the intermediate layer 104 may include a processing aid, such as a melt strength modifier. The inorganic filler, for example, may include talc, calcium carbonate, glass fibers, marble dust, cement dust, clay feldspar, silica or glass, fumed silica, alumina, magnesium oxide, magnesium hydroxide, antimony oxide, zinc oxide, iron oxide, barium sulfate, aluminum silicate, calcium silicate, titanium dioxide, titanates, glass microspheres, chalk, graphite, carbon black, or any combination thereof. In an example, the inorganic filler may be titanium dioxide, alumina, silica, zinc oxide, color pigments, clays, or any combination thereof. In particular, titanium dioxide may be used. In another example, the inorganic filler includes zinc oxide. In an example, the inorganic filler may be included in the intermediate layer 104 in an amount of at least 5% by weight, such as range of about 5% to about 80% by weight of the intermediate layer 104, a range of about 5% to about 60%, a range of about 5% to about 40% by weight, or even a range of about 5% to about 20% by weight of the intermediate layer 104. Further, the intermediate layer 104 may include a UV absorber or a blend of UV absorbers, such as a blend of UV absorbers available under the tradename Tinuvin® available from Ciba®.

In an example, the intermediate layer 104 may have a thickness not greater than about 1.0 millimeters, such as not greater than about 500 micrometers. For example, the intermediate layer 104 may have a thickness of not greater than about 100 micrometers, such as not greater than about 50 micrometers, not greater than about 25 micrometers, or even not greater than about 10 micrometers.

In a further exemplary embodiment, the capping film 110 optionally may include an adhesive layer 106. In an example, the adhesive layer 106 includes a polymer compatible with the polymer or polymer blend of the intermediate layer 104. For example, the adhesive layer 106 may include an acrylic adhesive. In another example, the adhesive layer 106 may include a blend of polymers.

In a particular example, the acrylic adhesive may be a thermal activated adhesive, such as a thermoplastic acrylic polymer. In another example, the acrylic adhesive may be a pressure sensitive adhesive.

In an alternative embodiment, an exemplary adhesive material includes a modified polyolefin, ethylene vinyl acetate, acrylic polymer, epoxy, or any combination thereof. In particular, the adhesive material may include maleic anhydride modified polyolefin. In another example, the adhesive material may include ethylene vinyl acetate with a peroxide agent.

In a particular example, the adhesive layer 106 may include a blend of polymers. For example, the adhesive layer 106 may include at least about 50% by weight of an adhesive material, such as at least about 60%, or even at least about 65% by weight of the adhesive material. In addition, the blend of polymers may include not greater than about 50% of a fluoropolymer, such as PVDF. For example, the blend may include not greater than about 40%, such as not greater than about 35% by weight of a fluoropolymer.

In an example, the adhesive layer 106 may have a thickness of not greater than about 1.0 millimeters, such as not greater than about 500 micrometers. For example, the adhesive layer 106 may have a thickness of not greater than about 100 micrometers, such as not greater than about 50 micrometers, not greater than about 25 micrometers, or even not greater than about 10 micrometers.

Further, the adhesive layer 106 may include curing aids or crosslinking components. In a particular embodiment in which the substrate layer 108 includes a curable component, the adhesive layer 106 may include a component to assist with forming a bond with the substrate layer 108 when the curable component of the substrate layer 108 is cured in contact with the adhesive layer 106. In addition, the adhesive layer 106 may include antioxidants, UV additives, antidegradation additives, adjuvants, or any combination thereof.

In an exemplary embodiment, the outer layer 102, formed of a damage resistant polymer component, comprises not more than about 35% by volume of the capping film 110. For example, the outer layer 102 may comprise not more than about 10% by volume, or not more than about 5% by volume of the capping film 110. The intermediate layer 104, formed of a component having desirable mechanical properties, may comprise greater than about 40% by volume of the capping film 110. For example, the intermediate layer 104 may form at least about 60% of the capping film 110, or even at least about 80% of the capping film 110. In an alternative example, in which the intermediate layer 104 is formed of multiple layers, the combined layers provide at least about 40% by volume of the capping film 110. Further, the adhesive layer 106 comprises not greater than about 40% by volume of the capping film 110, such as not greater than about 20% by volume of the capping film 110. In a particular embodiment, the capping film 110 is free of layer 106. For example, the capping film 110 may include layers 102 and 104, exclusive of other layers.

In a further exemplary embodiment, the capping film 110 has a desirable cold temperature elongation. The cold temperature elongation is the elongation at break, measured in accordance with ASTM D882, except at a temperature of −18° C. In particular, the capping film 110 may have a cold temperature elongation of at least 20%, such as at least 40%, at least 50%, or even at least 60%.

In an exemplary embodiment, the adhesive layer 106 adheres to and is in direct contact with the substrate layer 108, for example, without intervening layers. In another example, the capping film 110 may be free of layer 106 and layer 104 may directly contact the substrate layer 108. In a further alternative embodiment, a reinforcing material may be disposed between the capping film 110 and the substrate layer 108. The substrate layer 108 may be formed of a roofing substrate material. For example, the roofing substrate material may be formed of bitumen sheet material, such as a modified bitumen material.

In a particular example, the material of the roofing substrate layer 108 includes bitumen. For example, the bitumen may include heavy hydrocarbons. In particular, the bitumen may be modified, such as through blending with an elastomeric polymer or a plastic polymer.

In particular, the roofing substrate layer 108 may include bitumen modified with thermoplastic or elastomeric polymers. For example, the material of the roofing substrate layer 108 may include a polymer modifier, such as atactic polypropylene, amorphous poly alpha-olefin, thermoplastic polyolefin, styrene-butadiene-styrene, styrene-ethylene-butadiene-styrene, acrylonitrile-styrene-butadiene, other modifiers, or any combination thereof. For example, the bitumen may be an elastomer modified bitumen, such as an SBS modified bitumen, an ABS modified bitumen, or an SEBS modified bitumen. In another example, the bitumen may be a plastic modified bitumen, such as an atactic polypropylene modified bitumen. Further, the roofing substrate material may include at least about 20% by weight of bitumen or asphalt, such as about 45% to about 90% by weight, or about 45% to about 75% by weight of the bitumen or asphalt. Further, the roofing substrate material may include about 5% to about 80% by weight of a polymer modifier, such as about 5% to about 40% of the polymer modifier.

In an example, the substrate layer 108 may have a thickness of at least about 0.5 millimeters, such as at least about 1 millimeter. For example, the substrate layer 108 may have a thickness of at least about 2 millimeters, such as at least about 5 millimeters. In particular, the substrate layer 108 may have a thickness of at least about 10 millimeters.

As illustrated in FIG. 2, a multilayer roofing sheet material 200 may include a protective surface layer 202, such as a fluoropolymer layer. The protective surface layer 202 may overlay one or more intermediate layers 204. In addition, the one or more intermediate layers 204 may overlay an adhesive layer 206 and a roofing substrate layer 208.

In a particular example, the roofing substrate layer 208 may include bitumen. In addition, the roofing substrate layer 208 may include inorganic filler 212. For example, the inorganic filler 212 may include talc, calcium carbonate, glass fibers, marble dust, cement dust, clay feldspar, silica or glass, fumed silica, alumina, magnesium oxide, magnesium hydroxide, antimony oxide, zinc oxide, barium sulfate, aluminum silicate, calcium silicate, titanium dioxide, titanates, glass microspheres, chalk, or any combination thereof. In a particular example, the inorganic filler 212 also may act as pigment. For example, the pigment may be an aluminous material, such as an alumina or a hydrate of alumina. An alternative example of a filler 212 includes a carbonaceous filler, such as carbon black or graphite. The filler or pigment may be employed in amounts from about 1.0% to about 90.0% by weight, such as from about 10.0% to about 80.0% by weight, or even from about 20.0% by weight to about 50.0% by weight of the material of the roofing substrate layer 208.

In addition, the roofing substrate layer 208 may include reinforcement 210. For example, the reinforcement 210 may include metallic films, random fibrous reinforcement, woven reinforcement, or any combination thereof. In particular, the reinforcement 210 may include fiberglass, metallic strands, or polymeric fibers, such as polyester, aramid, or polyolefin fibers, or any combination thereof.

In a particular embodiment, the roofing sheet material exhibits desirable color stability. For cool roof systems, long-lasting light colors are preferred. Color stability may be indicated by measuring color change using a standard method called the CIE L*a*b* color model. Higher values of b* indicate a greater degree of yellow color. Increases in b* indicate yellowing. For example, the roofing sheet material may exhibit a b* Index of not greater than about 10.0. Resistance to discoloration may be characterized by exposing a roofing sheet material to UV radiation in a QUV tester at 60° C. with humidity for at least 450 hours and determining the change in b* value of the CIE L*a*b* scale. For example, the roofing sheet material may exhibit a b* Index of not greater than about 5.0, such as not greater than about 2.0, not greater than about 1.0, not greater than about 0.5, or even not greater than about 0.2.

Further, the roofing sheet material may have an initial solar reflectance, determined in accordance with ASTM E1980, of at least about 0.65, such as at least about 0.75. In addition, the roofing sheet material may have a solar reflectance after 3 years of service of at least about 0.50, such as at least about 0.65, or even at least about 0.75. Further, the roofing sheet material may have a thermal emissivity, determined in accordance with ASTM E408, of at least about 0.75, such as at least about 0.80, or even at least about 0.90.

In addition, the roofing sheet material exhibits desirable performance under cold conditions. For example, the roofing sheet material may have a desirable cold flex rating, defined as passing when the roofing sheet material does not break or crack when flexed around a 1 inch mandrel within 2 seconds at −18° C. using the testing method of ASTM D5147.6 as modified by ASTM D6164. The cold flex rating is designated failed if the roofing sheet material breaks or cracks when flexed at −18° C.

In an exemplary embodiment, the roofing sheet material may be formed through adhering a capping film to a substrate material. For example, the capping film may be formed through coextrusion or lamination. In a particular example, the layers of the capping film may be coextruded. In an alternative example, one or more layers of the capping film may be laminated to the other layers or extruded onto the other layers of the capping film. Coextrusion provides the capping film with a coherency and uniformity within the layers that leads to desirable mechanical properties not found in spray coatings.

In another embodiment, the capping film properties may be manipulated through changes in draw ratio, tentering, extrusion rates and temperatures, the use of blown film dies, or combinations thereof, or additional processing, such as tempering.

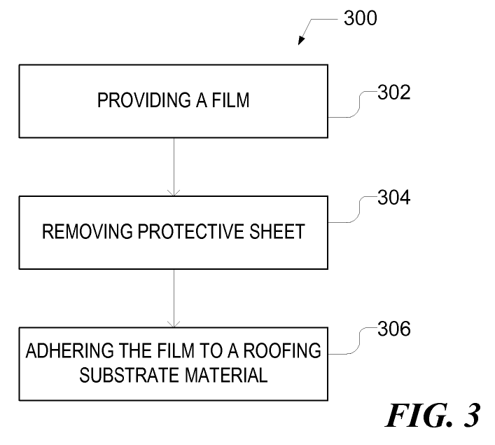

As illustrated in the exemplary method 300 of FIG. 3, the capping film may be provided, as illustrated at 302, such as dispensed from a roll. In a particular example, the capping film may include a releasable liner. As illustrated at 304, the releasable liner may be removed from the capping film.

Further, the capping film may be adhered to a roofing substrate material, as illustrated at 306. For example, the capping film may be heat laminated to a roofing substrate material. In another example, a roofing substrate material may be extruded and laminated to the capping film. For example, the roofing substrate material may be extruded or coated directly to the capping film.

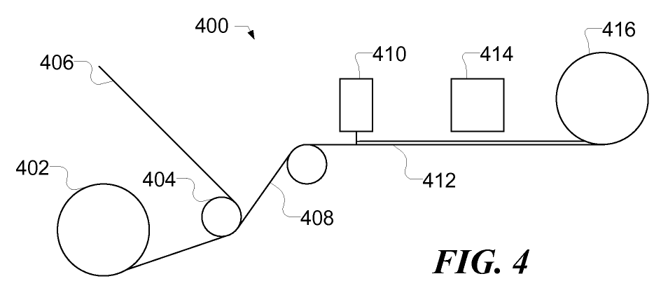

In a particular embodiment illustrated in FIG. 4, a capping film 402 that includes a releasable liner 406 is paid from a roll. In an example, the releasable liner 406 may be removed at tension roller 404 to provide the capping film 408 without the releasable liner 406.

The roofing substrate is dispensed for contact with the capping film 408. In an embodiment, an extruder 410 may extrude a roofing substrate material to contact the capping film 408 and form a roofing sheet material 412. As illustrated, the roofing substrate material is extruded on to the capping film 408. Alternatively, the roofing substrate material may be extruded on to a support film and the capping film 408 laminate over the roofing substrate material. In another embodiment, the capping film 408 may be coated, such as through dip coating.

In a particular example, the capping film may be adhered to the roofing substrate material through curing. For example, an adhesive of the capping film or an adhesive inserted between the capping film and the roofing material may be treated, such as heat treated or irradiated, to facilitate bonding. As illustrated, radiation source 414 may expose the extruded roofing sheet material 412 to electromagnetic radiation, including as UV radiation, or particle radiation, including electron beam radiation or gamma radiation.

Once formed and optionally bonded, the roofing sheet material may be rolled, as illustrated at 416. Alternatively, the roofing sheet material may be cut and packed. In a further alternative embodiment, a curable component of the roofing substrate material may be partially cured or left uncured and a releasable liner may contact the roofing substrate material to protect the uncured or partially cured component of the roofing substrate material. As such, the roofing sheet material can be further laminated to an additional substrate material or cured in place during installation of the roofing sheet material.

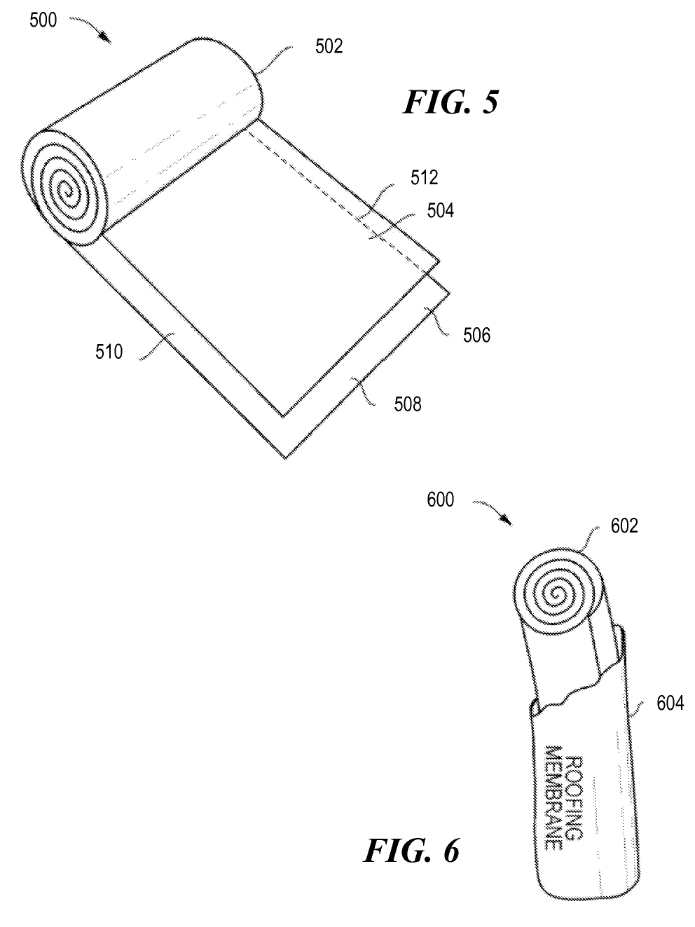

In a particular example, the film may be rolled for easy storage and merchandising. For example, FIG. 5 includes an illustration of an exemplary roofing sheet material or roofing material 500 in the form of a roll 502. The roofing sheet material 500 may include at least two layers 504 and 506. For example, the layer 504 may be a capping film that includes a low surface energy material, such as a fluoropolymer. The layer 506 may form a bulk layer that includes a bitumen material.

In the illustrative embodiment, the roofing sheet material 500 includes a terminal flap or tab 508 or a side flap or tab 510. The flaps or tabs 508 and 510 may be free of low surface energy material. For example, the layer 504 may at least partially overlie the layer 506. In a particular example, a portion of the layer 506 extends beyond an edge of the layer 504, forming the tab. In another exemplary embodiment, the roofing sheet material 500 may include a flap 512 that includes at least the material of layer 504. For example, the layer of 504 may extend beyond an edge of the layer 506, forming the flap or tab 512. During installation, the flap 512 or an additional film may be placed over the flap 510 of an adjacent sheet of the roofing sheet material 500. The flaps may include adhesive, such as partially cured diene elastomer or silicone adhesives, or an acrylic adhesive. During installation, the adhesive may be cured, bonding adjacent sheets of film together and reducing seams through which water may seep.

Alternatively, a flap, such as a flap 510, may extend from both sides of the sheet material 500. The roofing sheet material 500 may be placed adjacent another roofing sheet material to form a butt joint that may be covered with a tape or capping film. The tape or capping film may be adhered to the butt joint with an adhesive. For example, the capping film may include an adhesive layer.

The rolls of film may be sold as a merchandised article, such as the merchandised article 600 illustrated in FIG. 6. The merchandised article 600 may include a roll of the roofing sheet material 602 and a mark indicating use of the sheet material as a roofing material. For example, the merchandised article 600 may include packaging 604 having writing or markings indicating that the packaged roll 602 is a roofing sheet material. Alternatively, a marking or indicator, such as lettering, may be printed on the roll 602. In a further exemplary embodiment, the marking or indicator may be a tag wrapped around the roll 602 or attached to a band securing the roll 602.

In an exemplary embodiment, a roofing material may be formed by bonding a roofing sheet material to a bulk layer. For example, a roofing sheet material may be formed separately from the bulk layer and the roofing sheet material and bulk layer may be thermally bonded or laminated with or without an intervening adhesive layer. The intervening adhesive layer may be added during the laminating process or formed as part of the bulk layer or of the roofing sheet material. In a particular embodiment, the bulk layer may be another roofing sheet material preinstalled on a roof. As such, the roofing sheet material may be used to repair or overly other pre-existing roofing materials. For example, the roofing sheet material may be laminated to a previously installed bulk layer.

Alternatively, the capping film, as described above, may be used to retrofit existing roofing structures. In a particular example, an existing roofing sheet material may be cleaned and the capping film may be laminated to the existing roofing sheet material in place. For example, an adhesive may be used to bond the capping film to the roofing sheet material. In another example, the capping film may include an uncured or partially cured layer (i.e., an at least partially uncured layer) that is cured to bond the capping film to the roofing sheet material. In a particular example, the roofing sheet material may include a bitumen roofing material. In another exemplary embodiment, a bulk layer is bonded to a roofing structure and the capping film is laminated to the bulk layer in-place.

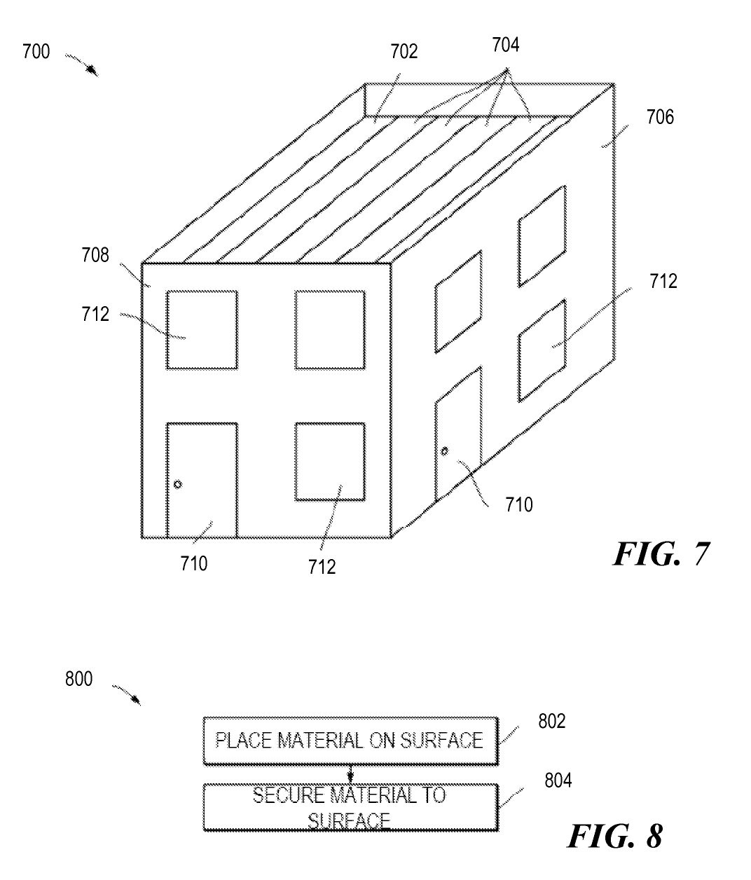

The roofing material may be installed on a building, as illustrated at FIG. 7. For example, a building 700 may include outdoor surfaces 702, 706 and 708. In a particular example, the skyward facing surface 702 is covered with a roofing sheet material 704. As illustrated, the skyward facing surface 702 is a low slope surface. For example, a low slope surface may have a slope not greater than about 10°. Generally, low slope roofing is useful in large commercial buildings. In an alternative embodiment, the skyward facing surface 702 may be a sloped roof. Generally, sloped roof systems are useful in residential structures.

While the sheet material 704 is illustrated in connection with the skyward facing surface 702, the sheet material 704 also may be installed on vertical surfaces 706 or 708. Such vertical surfaces 706 or 708 may include windows 712 and doors 710. When installed on vertical surfaces, such as the surfaces 706 and 708, the multi-layer sheet material is installed on regions of the surface that do not include the windows 712 or the doors 710.

FIG. 8 includes an illustration of an exemplary method for installing a multi-layer sheet material. The method 800 includes placing a multi-layer sheet material on a surface, as illustrated at 802. For example, the surface may be a skyward facing surface of a commercial building. Such surfaces are typically low-slope roofs. However, the sheet material may also be placed over a sloped roof, such as the roofs typically used in single family residential structures. In a particular embodiment, the films are unrolled to form elongated sheets lying side by side over the roof.

The sheet material may be secured to the surface, as illustrated at 804. For example, the sheet material may be secured to the roof using an adhesive. In a particular embodiment, the sheet material may be secured using a hot tar or pitch as adhesive. The sheet material may be placed over the hot tar of pitch and the hot tar or pitch allowed to cool. In an alternative embodiment, the sheet material may be thermally secured to the surface. For example, the sheet material may be heated to a softening or melting point and pressed onto the roof surface. In such a manner, thermal plastic portions of the multi-layer sheet material may adhere to the roof. In another example, heating the sheet material may activate thermal curing agents within the sheet material, resulting in bonding of the sheet material to the roof structure. In alternative embodiments, the sheet material may be secured to the roof using a mechanical method, such as nails, screws, or flashings.

Particular embodiments of the roofing sheet material exhibit technical advantages over prior roofing sheet materials. For example, embodiments of the roofing sheet material described above exhibit decreased discoloration over time. In particular, such decreased discoloration may lead to lower roof temperatures. In addition, the roofing sheet materials exhibit desirable cold temperature performance. For example, embodiments of the roofing sheet materials pass the cold flex rating test, and the capping film exhibits a desirable cold temperature elongation. Further, embodiments of the capping film retain volatile organic compounds within the substrate layer, maintaining the flexibility of the substrate layer over an extended life of the roofing sheet material.

### EXAMPLE 1

Two films are laminated to the surface of an SBS-modified bitumen roofing sheet material.

In a preparation, a PVDF polymer, an acrylic polymer, and TiO₂ are blended to form a Formulation 1. Formulation 1 includes the PVDF polymer in an amount of about 20% to about 55% by weight, the acrylic polymer in an amount of about 15% to about 50% by weight, and the TiO₂ in an amount of about 10% to about 30%. Additionally a PVDF polymer and an acrylic polymer are blended to form a Formulation 2. Formulation 2 includes the PVDF polymer in an amount of about 20% to 50% by weight and the acrylic polymer in an amount of about 50% to 80% by weight. Film 1 is formed as a three layer structure: PVDF/Formulation 1/Formulation 2. Film 2 is formed as a two layer structure FEP/crosslinked EPDM.

Both Film 1 and Film 2 are laminated to the surface of the SBS-modified bitumen roofing, resulting in Sheet material 1 and Sheet material 2, respectively. The sheet materials are exposed to UV radiation in a QUV tester at 60° C., with humidity. The sheet materials are observed for color change based on the b* rating on an L-a-b scale.

Sheet material 1 exhibits a change in b* of −0.185 over a 498 hour exposure and as such, exhibits a b* Index of less than −0.185. In contrast, Sheet material 2 exhibits a change in b* of 15.78 after only 96 hours and thus, exhibits a b* Index of at least about 15.78.

### EXAMPLE 2

In a preparation, a PVDF polymer, an acrylic polymer, and TiO₂ are blended to form a Formulation 1. Formulation 1 includes the PVDF polymer in an amount of about 20% to about 55% by weight, the acrylic polymer in an amount of about 15% to about 50% by weight, and the TiO₂ in an amount of about 10% to about 30%. In addition, a Formulation 2 includes a blend of about 50% to about 80% by weight acrylic polymer and about 20% to about 50% by weight PVDF polymer. Film 1 is formed as a three layer structure: PVDF/Formulation 1/Formulation 2. Film 2 is formed as a two layer structure FEP/crosslinked EPDM.

Both Film 1 and Film 2 are laminated to the surface of the SBS-modified bitumen roofing, resulting in Sheet material 1 and Sheet material 2, respectively. The resulting sheet materials are allowed to sit in a laboratory hood at room temperature for a period of several days. During this time, b* measurements are made at increasing times. The Table 1 below indicates the rapid discoloration of Sheet 2, without the barrier layer, and the resistance to discoloration of Sheet 1 sheet including the barrier material. Sample films including intermediate layers with greater amounts of PVDF exhibit little change in b* values.

TABLE 1

| Time | | |
|---|---|---|
| elapsed | Sheet 1 | Sheet 2 |
| (hours) | b* | B* |
| 0 | 0.58 | 3.14 |
| 5 | 0.39 | 3.44 |
| 20 | 0.14 | 4.34 |
| 27 | 0.47 | 4.57 |
| 44 | 0.57 | 4.93 |
| 51 | 0.55 | 5.19 |
| 68 | 0.56 | 5.52 |
| 75 | 0.48 | 5.78 |
| 140 | 0.60 | 7.64 |
| 236 | 0.66 | 9.80 |
| 478 | 0.54 | 13.99 |

### EXAMPLE 3

PVDF (KynarFlex 2850)/Acrylic blends are prepared by weighing out the ratios specified in TABLE 3 and melt-mixing at 200° C. in a Braebender Plasti-Corder Torque Rheometer. Films are prepared by hot-pressing at 200° C. TABLE 2 lists the components and TABLE 3 lists the blend compositions.

TABLE 2
Materials and Suppliers

| Generic Name | Grade | Supplier |
|---|---|---|
| PVDF | Kynar Flex 2850 or 2800 | Arkema |
| Acrylic | Solarkote P-600 | Arkema |
| TiO2 | Ti-Pure R-105 | DuPont |

TABLE 3
Sample Compositions
Table 1: Blend Compositions for Example 1

| Blend Name | 1 | 2 | 3 | 4 | 5 | 6 |
|---|---|---|---|---|---|---|
| Wt % TiO2 | 10 | 20 | 10 | 20 | 10 | 20 |
| Wt % PVDF | 54 | 48 | 63 | 56 | 72 | 64 |
| Wt % Acrylic | 36 | 32 | 27 | 24 | 18 | 16 |
| PVDF/Acrylic | 60/40 | 60/40 | 70/30 | 70/30 | 80/20 | 80/20 |
| Blend Ratio | | | | | | |

Laminates of surface film bonded to the Mod-Bit substrate (selvage of CertainTeed Flintastik SA Capsheet) are prepared by hot-roll-pressing at 300° F. For Cold Flex testing, samples are stored in a freezer at −18° C. (0° F.) overnight together with the 1-inch mandrel. Cold Flex tests are performed by bending samples around a 1 inch mandrel within 2 seconds as specified by ASTM D5147. Six specimens are tested at each condition. Cold Flex test results are reported in terms of percent pass in which no cracks are visible on the surface film. In addition, tensile tests are conducted at T=−29° C. to obtain the % Elongation-to-Break. The test is performed 5 times for each sample. The results of the Cold Flex tests at T=−18° C. as well as Elongation-to-Break at T=−29° C. are presented in TABLE 4.

TABLE 4
Cold Flex and Elongation for Samples

| | 1 | 2 | 3 | 4 | 5 | 6 |
|---|---|---|---|---|---|---|
| Cold Flex | 83% | 83% | 100% | 33% | 60% | 0% |
| | pass | pass | pass | pass | pass | pass |
| Elongation- | 71 | 50 | 56 | 13 | 21 | 13 |
| to-Break (%) | | | | | | |

As illustrated in TABLE 4, a blend including at least 60% of the PVDF copolymer and a ratio of 7:3 fluoropolymer to acrylic exhibits the highest pass rate. A laminate of the Acrylic (Solarkote P-600) without TiO₂ prepared in the same way provides a 0% pass of the Cold Flex test and an Elongation-to-Break of 6.3%.

### EXAMPLE 4

Films of blends 1 and 3 from EXAMPLE 3 are prepared via compounding and extrusion. The samples were extruded at 220° C. (428° F.) with draw ratios of approximately 8.3. Cold Flex tests at −18° C. and tensile tests at −29 C are performed in both the machine direction (MD) and transverse direction (TD).

TABLE 5
Cold Flex and Elongation by Direction Relative to Extrusion

| | 1 MD | 1 TD | 3 MD | 3 TD |
|---|---|---|---|---|
| Cold Flex | 100% pass | 0% pass | 90% pass | 0% pass |
| Elongation- | 63 | 4.9 | 62 | 4.7 |
| to-Break (%) | | | | |

As illustrated, the extrusion process may introduce a structural anisotropy which influences Cold Flex performance and Elongation-to-Break in the transverse direction (TD). Preferably, extrusion processes and conditions are selected that result in greater elongation in both directions.

### EXAMPLE 5

Blends of increasing acrylic fraction were compounded and extruded (TABLE 6). In this case, Kynar Flex 2800 available from Arkema is used, which is believed to be a copolymer of VDF and HFP with a nominal HFP content of approximately 10%.

TABLE 6
Sample Compositions

| | 7 | 8 | 9 |
|---|---|---|---|
| Wt % TiO2 | 10 | 10 | 10 |
| Wt % PVDF | 36 | 45 | 54 |
| Wt % Acrylic | 54 | 45 | 36 |
| PVDF/Acrylic | 40/60 | 50/50 | 60/40 |
| Blend Ratio | | | |

Cold Flex tests at −18° C. and Tensile tests at −29° C. are conducted in the transverse direction (TD). These Cold Flex tests are carried out by laminating the surface film to the self-adhesive (reverse)-side of the granule-coated part of the Mod-Bit product, not the selvage as is the case of EXAMPLES 3 and 4. The 9 sample was produced with a draw ratio of 5.

TABLE 7
Cold Flex and Elongation for Samples

| | 7 TD | 8 TD | 9 TD |
|---|---|---|---|
| Cold Flex | 100% pass | 20% pass | 0% pass |
| Elongation- | 29 | 38 | 2.3 |
| to-Break (%) | | | |

While the samples including more acrylic exhibited desirable cold temperature performance in the transverse direction, it is believed that this variance resulted from changes in draw ratio and processing conditions. As illustrated, at least a minimum cold temperature elongation is believed to influence the transverse direction cold temperature performance, which may also be achieved with higher ratios of PVDF under different processing conditions. Of additional concern is the permeability of the films to volatile organic compounds, which is undesirable in bitumen roofing material applications. High ratio samples are impermeable to volatile organic compounds. In addition, low ratio samples may suffer from shrinkage.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A roofing material comprising:
a bitumen sheet material; and
a multilayer capping film comprising:
a first layer comprising a first fluoropolymer; and
a second layer underlying the first layer, the second layer comprising at least 40 wt % of a second fluoropolymer mad not greater than 60 wt % of an acrylic polymer;
wherein the second layer of the multilayer capping film overlies the bitumen sheet material and wherein the first layer of the multilayer capping film forms an outer surface of the roofing material.

2. The roofing material of claim 1, wherein the first fluoropolymer includes a vinylidene fluoride homopolymer or copolymer.

3. The roofing material of claim 2, wherein the first fluoropolymer includes a vinylidene fluoride copolymer including hexafluoropropylene.

4. The roofing material of claim 1, wherein the second fluoropolymer includes a vinylidene fluoride homopolymer or copolymer.

5. The roofing material of claim 4, wherein the second fluoropolymer is the same as the first fluoropolymer.

6. The roofing material of claim 4, wherein the second fluoropolymer includes a vinylidene fluoride copolymer including hexafluoropropylene.

7. The roofing material of claim 6, wherein the vinylidene fluoride copolymer includes the hexafluoropropylene in a range of 5 wt % to 30 wt %.

8. (canceled)

9. (canceled)

10. The roofing material of claim 1, wherein the acrylic polymer includes an impact modified acrylic polymer.

11. The roofing material of claim 1, wherein the second layer includes greater than 50 wt % of the second fluoropolymer.

12. The roofing material of claim 11, wherein the second layer includes at least 60 wt % of the second fluoropolymer.

13. (canceled)

14. The roofing material of claim 1, wherein the second layer includes less than 50 wt % of the acrylic polymer.

15. (canceled)

16. The roofing material of claim 1, wherein the second layer comprises an inorganic filler.

17. (canceled)

18. (canceled)

19. The roofing material of claim 16, wherein the inorganic filler includes a metal oxide particulate.

20. (canceled)

21. (canceled)

22. The roofing material of claim 1, wherein the bitumen sheet material includes modified bitumen.

23. The roofing material of claim 22, wherein the modified bitumen includes elastomer modified bitumen.

24. The roofing material of claim 23, wherein the bitumen sheet material includes a reinforcement.

25. (canceled)

26. (canceled)

27. (canceled)

28. (canceled)

29. The roofing material of claim 1, wherein the multilayer coextruded capping film has a cold temperature elongation of at least 20%.

30. (canceled)

31. (canceled)

32. (canceled)

33. The roofing material of claim 1, wherein the roofing material has a cold flex rating of pass.

34. The roofing material of claim 1, wherein the multilayer capping film further comprises a third layer comprising an adhesive.

35. (canceled)

36. The roofing material of claim 1, wherein the multilayer capping film is a coextruded film.

37. (canceled)

38. (canceled)

39. (canceled)

40. (canceled)

41. (canceled)

42. A capping film comprising:
coextruded first and second layers;
the first layer comprising a fluoropolymer; and
the second layer comprising greater than 50 wt % of a vinylidene fluoride copolymer, not greater than 40 wt % acrylic polymer; and at least 5 wt % of an inorganic filler, the vinylidene fluoride copolymer including 5 wt % to 30 wt % hexafluoropropylene.

43. The capping film of claim 42, wherein the second layer includes at least 55 wt % of the vinylidene fluoride copolymer.

44. (canceled)

45. (canceled)

46. The capping film of claim 42, wherein the acrylic polymer includes an impact modified acrylic polymer.

47. (canceled)

48. (canceled)

49. (canceled)

50. The capping film of claim 42, wherein the capping film has a cold temperature elongation of at least 20%.

51. (canceled)

52. A method of forming a roofing material, the method comprising:
dispensing a bitumen sheet material;
dispensing a capping film, the capping film comprising:
a first layer comprising a first fluoropolymer and forming an outer layer; and
a second layer underlying the first layer, the second layer comprising at least 40 wt % of a second fluoropolymer and not greater than 60 wt % of an acrylic polymer; and
laminating the capping film to the bitumen sheet material.

53. (canceled)

54. (canceled)

55. (canceled)

56. (canceled)
